(19) United States
(12) Patent Application Publication
(10) Pub. No.: US 2006/0205919 A1
(43) Pub. Date: Sep. 14, 2006

(54) Derivatives of end capped polysuccinimides

(76) Inventors: Graham Swift, Chapel Hill, NC (US); George H. Redlich, East Norriton, PA (US)

Correspondence Address: STAMATIOS MYLONAKIS, 7009 CASHELL MANOR COURT, DERWOOD, MD, 20855-1201, US

(21) Appl. No.: 11/368,794

(22) Filed: Mar. 6, 2006

Related U.S. Application Data
(60) Provisional application No. 60/659,436, filed on Mar. 9, 2005.

(51) Int. Cl. C08G 73/14; C08G 69/00

(52) U.S. Cl. 528/322; 528/332

(57) ABSTRACT

Disclosed are methods of forming amides or esters and mixtures thereof by reacting an end capped polysuccimide polymer with an amine, an alcohol or a mixture thereof in the absence of water and methods of forming an amide by reacting an end capped polysuccimide polymer with an amine in the presence of water.

This application claims priority from U.S. Provisional application 60/659,436, filed Mar. 9, 2005, which is incorporated herein by reference in its entirety.

### BACKGROUND OF THE INVENTION

1. Field of the Invention

The present invention relates to a process for the preparation of derivatives such as amide, ester and mixtures thereof, from end capped polysuccinimide.

2. Discussion of the Related Art

End capped polysuccinimide polymers have been discussed in U.S. applications Ser. Nos. 10/834,908 and 10/834,909 both filed Apr. 30, 2004, both of which are incorporated herein by reference in their entirety.

### SUMMARY OF THE INVENTION

One aspect of the present invention relates to a polymerization of L-aspartic acid, in the presence of an end capping initiator, such as an anhydride, a carboxylic acid, an ester or an amine to form end capped polysuccinimide, and further reacting the end capped polysuccinimide with an amine substantially in the absence of water to form an amide derivative. In another aspect the end capped polysuccimide is reacted with an alcohol substantially in the absence of water to form an ester derivative. In a further aspect of the present invention the end capped polysuccinimide polymer is reacted with a mixture of an alcohol and an amine to form a mixed amide-ester derivative. In an additional aspect of the present invention the end capped polysuccinimide polymer is reacted in a aqueous amine solution to form an amide derivative. The above reactions may take place in the presence of a catalyst.

### DESCRIPTION OF THE PREFERRED EMBODIMENTS

A. Formation of an End Capped Polysuccinimide Polymer

End capped polysuccinimide polymers are formed as described in U.S. application Ser. No. 10/834,908 filed Apr. 30, 2004, which is incorporated herein by reference in its entirety. Accordingly, a polymeric material containing succinimide or aspartate moieties is formed by end capping polymerization. The term “polymeric material containing succinimide or aspartate moieties” is used herein to denote a polysuccinimide, a polyaspartate, an oligomer containing succinimide or aspartate moieties or a prepolymer containing succinimede or aspartate moieties. The term “oligomer” as used in the present application denotes a polymeric material with a degree of polymerization (DP) between 2 and 50. The term “prepolymer” is used herein to denote a polymeric material with low molecular weight, preferably from 100 to 1,000 weight average molecular weight (Mw). The term “end capping” is used in the present application to denote the initiation of chain growth polymerization. An end capping initiator in accordance with the present invention is represented by an anhydride of formula (A), an amine of formula (B), an acid of formula (C) or an ester of formula (D) below:

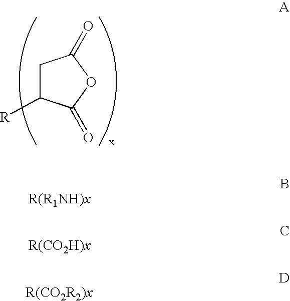

where x is an integer from 1 to 1000, including any integers within this range, preferably from 1 to 100, more preferably from 1 to 10, most preferably from 1 to 5; R, R₁ and R₂, are the same or different radicals selected from the group consisting of hydrogen, an alkyl, such as methyl, ethyl, n-propyl, isopropyl, n-butyl, isobutyl, sec-butyl, n-amyl, isoamyl, n-hexyl, n-octyl, capril, n-decyl, lauryl, myristyl, cetyl, and stearyl; substituted alkyl, such as hydroxyethyl, polyoxyalkyl; alkenyl, such as allyl; aryl, such as phenyl, naphthyl; aryl-alkyl, such as benzyl; or substitute aryl radical, such as alkylphenyl, chlorophenyl and nitrophenyl. In one embodiment R₁ is independently a hydrogen atom. In another embodiment R and R₁ in formula (B) are hydrogen atoms. Further, R may also contain a functional group (radical), provided the functional group on R does not react with another functional group on the same molecule. In other words, R in formula (A) cannot contain an amine functional group that would react with the anhydride on the same molecule.

Accordingly, when x is 1, a linear copolysuccinimide or polyaspartate is formed; when x is 2, a linear copolysuccinimide or polyaspartate is also formed, however, the molecular weight of the copolysuccinimide or polyaspartate builds up from both functional groups of the end capping initiator; further, when x is 3 or higher, a star copolysuccinimide or polyaspartate is formed as a result of the initiation of polymer chains from all functional groups present on the end capping initiator.

The aspartic acid or aspartate salt is dried as described under Section A of the specification of the above identified application Ser. No. 10/834,908, for Thermal Synthesis of Poly(succinimide-aspartate), except that the aspartic acid is mixed with an end capping initiator prior to drying. The polymerization proceeds by subjecting the mixture in solid phase polymerization, melt polymerization in an extruder as described below, in a rotary evaporator, in dispersion or solution in oil, in phosphoric acid, or other strong acids that function as catalysts, in the absence of a salt, in supercritical fluids or any other method. If the monomer is aspartic acid polysuccinimide is formed; additional comonomers may be present, as discussed under the thermal process above.

An end capping initiator with at least one amine functionality, will react with the acid functionality of aspartic acid and the final polymeric product will be in the absence of any carboxyl functional groups. Likewise, an end capping initiator with at least one carboxyl group will react with the amine functionality of the aspartic acid and the final product will be in the absence of any amine functionality. Further, polymeric end capping initiators, in other words end capping initiators with a polymeric backbone and containing at least one functionality such as an amine, a carboxy or an anhydride or an ester, are within the scope of the present invention.

Non binding examples are shown below using an anhydride, such as succinic anhydride, as shown in Reaction 1, an acid, such as succinic acid, as shown in Reaction 2 and an amine, as shown in Reaction 3 to form polysuccinimide:

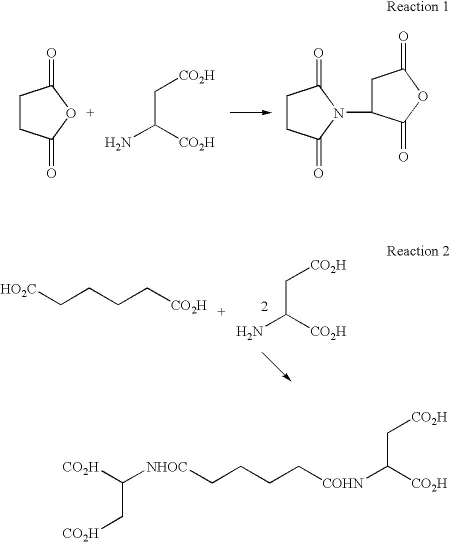

In Reactions 1 and 2 either acid or anhydride end groups are possible depending on reaction conditions. Thus, the anhydride reacts with the amino group of the L-aspartic acid to form an amide bond which then cyclizes to form the succinimide moiety. Meanwhile the carboxyl group of the L-aspartic acid reacts with the amino group of another L-aspartic acid, to build up the chain length of copolysuccinimide or polyaspartate, and then cyclizes. This proceeds until the L-aspartic acid is used up. In the case where the L-aspartic acid is the final group, the carboxyl groups cyclize to form the anhydride. Thus, in an additional embodiment of the present application a polyanhydride is formed, wherein the term “polyanhydride” is used to denote a polymer containing two or more anhydride moieties.

Suitable end capping initiators used to initiate polymerizations containing chosen end groups in accordance with the present invention, include but are not limited to an anhydride such as succinic anhydride; phthalic anhydride; maleic anhydride; itaconic anhydride, alkenyl succinic anhydride, which leaves a hydrocarbon chain with a double bond; 1,2,4-benzenetricarboxylic anhydride; cis-1,2,3,6-tetrahydrophthalic anhydride; 1,2-cyclohexane dicarboxylic anhydride; or a carboxylic acid, such as an acid of the general formula: CH₃(CH₂)ₙCOOH, where n is from 0 to 16; a dibasic acid of the general formula: HOOC(CH₂)ₙCOOH, where n is from 4 to 16; particular examples of acids include but are not limited to oxalic acid; benzoic acid; thiolsuccinic acid, which would leave a thiol end group; terephthalic acid; succinic acid; phthalic acid; maleic acid; itaconic acid,lactic acid, malic acid; alkenyl succinic acid; 1,2,4-benzenetricarboxylic acid; cis-1,2,3,6-tetrahydrophthalic acid; and 1,2-cyclohexane dicarboxylic acid, adipic acid and azelaic acid, as well as esters of the above acids. From the known concentration of the initiator the molecular weight of the chain, that is the chain length, can be controlled by controlling the amount of the monomers used. Additional examples include polymeric materials containing at least one pendant carboxyl functionality or at least one pendant anhydride functionality, such as an acrylate copolymer containing an acrylic, methacrylic or itaconic acid moiety, or a polymer containing a maleic anhydride moiety, such as styrene-maleic anhydride copolymer (SMA).

In another embodiment of the present application the end capping initiator is an amine, as shown in Reaction 3 below: 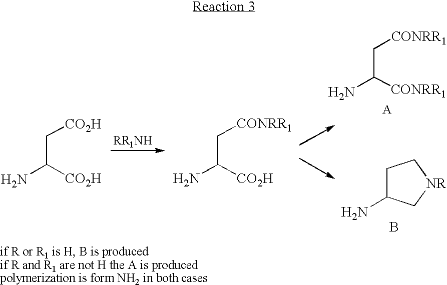
If R or R₁ is H, B is produced; if R and R₁ are not H, A is produced; polymerization takes place from NH₂ in both cases; where R, and R_{1,} are the same or different radicals selected from the group consisting of an alkyl, such as methyl, ethyl, n-propyl, isopropyl, n-butyl, isobutyl, sec-butyl, n-amyl, isoamyl, n-hexyl, n-octyl, capril, n-decyl, lauryl, myristyl, cetyl, and stearyl; substituted alkyl, such as hydroxyethyl; alkenyl, such as allyl; aryl, such as phenyl; aryl-alkyl, such as benzyl; or substitute aryl radical, such as alkylphenyl, chlorophenyl and nitrophenyl. In one embodiment of the present invention R₁ is independently a hydrogen atom. Included are alkoxylated amines and diamines.

Accordingly, suitable end capping initiators containing at least one amine group which reacts with the carboxylic group of the L-aspartic acid to form polysuccinimide include but are not limited to, an aliphatic amine, such as methylamine, dimethylamine, ethylamine, diethylamine, n-propylamine, di-n-propylamine, n-butylamine, n-amylamine, aminopyridin, imidazole, n-hexylamine, laurylamine; an aliphatic diamine, such as ethylenediamine, trimethylenediamine, tetramethylenediamine, pentamethylenediamine, hexamethylenediamine; an aliphatic hydroxylamine, such as ethanolamine, diethanolamine; an aromatic amine, such as aniline, methylaniline, ethylaniline, o-toluidine, m-toluidine, p-toluidine; and an aromatic diamine, such as o-phenylenediamine, m-phenylenediamine and p-phenylene diamine; additional amines in accordance with the present invention include but are not limited to diamine alkoxylate, 12-aminododecanoic acid, 11-aminoundecylenic acid, piperidine and 1,6-diaminohexane. End capping initiators containing different functional groups are also within the scope of the present invention. Such initiators include 6-aminohexanoic acid. Included are branched or star copolymers formed from polyfunctional amines used as end capping initiators. A non binding example is shown below in Reaction 4: 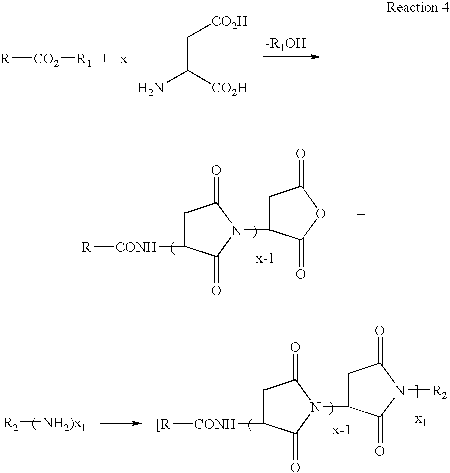
where R, R₁, R₂, are as defined previously, and x and x₁ refer to the degree of polymerization. Thus, in accordance with Reaction 4, a polysuccinimide is formed with a succinic anhydride end group; the succinic anhydride further reacts with a polyamine to form branched polysuccinimide.

In a further embodiment the anhydride end group is reacted with an aminoethoxylate, hydrophobic amine, or hydroxyl terminated materials. Additional suitable nucleophiles include but are not limited to a poly(vinyl alcohol); a polyester; a polyamide; a polysaccharide, such as starch; a dextran; and a cellulose; a protein; a dye; and a UV absorber. The anhydride reacts considerably faster than the succinimide moieties within the chain. Also included are polymeric materials containing at least one functionality selected from an anhydride, amine, carboxylic acid or ester functionality, such as styrene-maleic anhydride copolymer and a polymeric polyamine. Preferably the polymeric materials containing at least one functionality exhibit a (Mw) weight average molecular weight higher than 1,000, more preferably from 2,000 to 5,000, including all increments within this range.

Thus, in an embodiment in accordance with the present invention, the polymer formed by end capping initiation contains specific chain end functionality, introduced to the polymer by the choice of the end capping initiator.

In another embodiment the polymerization in the presence of the end capping initiator is carried out in a solvent, such as water, in a supercritical fluid, in the molten phase or in the solid phase.

In another embodiment of the present invention a prepolymer is formed. The term “prepolymer” is used herein to denote a polymer with low molecular weight, preferably from 100 to 1,000 weight average molecular weight. Subsequently the polymerization proceeds in the absence of the end capping initiator as described above in the thermal and supercritical fluid polymerizations, or in the molten phase or in the solid phase.

An advantage of this approach is that the end capping reaction improves significantly the color of the final product. Although Applicants do not wish to be bound to any theories, they believe that this is due to the fact that the process is not on the basic side and the amine groups are tied up rapidly. Interestingly, it has been found that the color gets better as the ratio of the end capping chain initiator (CI) to L-aspartic acid (AA), CI:AA, increases. The ratio of the end capping initiator to polymerizing L-aspartic acid controls the Mw of the polymer formed. Accordingly, preferred ratios depend on the desired Mw of the polymer formed. Preferred molar ratios include but are not limited to, from 1:1 to 1:1000 including all ratios within this range, such as from 1:1 to 1:100, from 1:1 to 1:10, or from 1:1 to 1:5.

In another embodiment by properly controlling the ratio of CI:AA discussed above as well as the chain initiating group a material is formed in the molten state at the reaction temperature which is amenable to processing via extrusion, as described below.

Another advantage lies in the anhydride end of the chain in that further reaction can be initiated from that end. For example, other monomers can be used to build chains exhibiting greater flexibility, hydrophobicity or a specific hydrophobic/hydrophilic value. In one of the embodiments a block copolymer is formed in this manner.

In another embodiment in accordance with the present invention an oligomer is formed in an extruder and subsequently an additional monomer or mixture of monomers is introduced in the extruder through an injection port as shown in FIG. 1. One can envision the preparation of numerous products, with controlled weight average molecular weight (Mw) ranging from 1,000 to 500,000, including all increments within that range, preferably from 1,000 to 50,000, more preferably from 2,000 to 10,000 Daltons, in one continuous process. As pointed out above, the ratio of the end capping initiator to polymerizing monomer(s) controls the Mw of the polymer.

The rheology of the starting materials in the extruder, in accordance with the present invention, is a function of the end group, type of comonomer and molecular weight of comonomer. Comonomers with plasticizing effect, such as 11-aminoundecylenic acid and 12-aminododecanoic acid, are useful in reducing the rheology and improving processability.

In another embodiment, a copolymer formed by the end capping initiation of the present invention is derivatized by reacting a nucleophile with a succimide ring. In this process an end-capped oligomer is formed, which subsequently is chain extended and finally derivatized to form a final product. The entire process is preferably carried out in an extruder. Crosslinking and crosslinked copolymers are also within the scope of the present application. Crosslinking occurs when the end capping initiation takes place in the presence of a multifunctional monomer, such as a diamine, lysine or a polyamine.

Additional suitable monomers which can be used to chain extend, besides L-aspartic acid, include but are not limited to a dicarboxy amino acid, a hydroxy acid, and combinations of a diamine or a diol with a dicarboxylate to form a polyamide or a polyester.

Additional monomers or comonomers in accordance with the present invention include but are not limited to glutamic acid, α,ε-diaminopimelic acid and γ-methylene glutamic acid.

In an additional embodiment the succinimide moieties react with aminoethoxylate, hydrophobic amine, or hydroxyl terminated materials to form a graft copolymer, such as a comb-graft copolymer or a copolymer having a hyperbranched structure. The term “hyperbranched” as used herein denotes a core molecule with at least three other molecules (branches) connected to the core molecule.

Proper control of the molecular weight and the functionalities result in dispersants, surface active agents, rheology modifiers, thickeners, corrosion inhibitors, sun screens, gels in water or in solvents, etc.

Preferably the end capping reaction is carried out in the presence of a catalyst. Suitable catalysts include but are not limited to a protonic acid, such as polyphosphoric acid; a Lewis acid; an organometallic catalyst, preferably one of those used for condensation reactions, such as tin octanoate.

In another embodiment of the present invention the end capping reaction is initiated via the amino group in the presence of a primary or secondary amine.

In another embodiment the resin formed in accordance with the present invention is stabilized with polymer additives before or after isolation. Polymer additives are discussed in the Modern Plastics Encyclopedia, A Division of McGraw Hill Companies, 72, pages C-3 to C-117 (1995) and in Kirk-Othmer Concise Encyclopedia of Chemical Technology, John Wiley & Sons, New York, pages 129-130 (1985), both of which are incorporated herein by reference.

In another embodiment of the present invention, the preparation of a derivative in accordance with the present invention is carried out in the presence of a thermal stabilizer or an antioxidant or a mixture thereof as discussed below.

B. Reaction of an End Capped Polysuccinimide Polymer with an Amine, Alcohol or a Mixture of an Amine and an Alcohol in the Absence of Water

In an embodiment in accordance with the present invention the end capped polysuccinimide polymer reacts with an amine, substantially in the absence of water, to form an amide. The term substantially is used herein to denote a water content of not more than 0.1 wt. percent. In another embodiment the end capped polysuccinimide polymer reacts with an alcohol, substantially in the absence of water, to form an ester. In a further embodiment of the present application the end capped polysuccinimide polymer reacts with a mixture of an alcohol and an amine to form a mixture of an amide and ester. The reaction may also be carried out in the presence of a catalyst. The reactions are shown in Reaction 5 below.

Suitable amines in accordance with the present application are any primary amine, a secondary amine or a mixture thereof. Suitable amines include but are not limited to ethylamine, propylamine and the homologous series, ethanolamine, diethanolamine, glycolamine, an aminopolyethoxylate, an amino acid, imidazole, morpholine, an aromatic amine, a polymeric amine, a protein and chitosan.

Further, any primary alcohol, a secondary alcohol and mixtures thereof can be used in accordance with the present invention. Additional suitable alcohols include but are not limited to a synthetic or natural alcohol that is primary or secondary, a starch, a cellulose, a poly (vinyl alcohol), an aliphatic or aromatic alcohol, such as a phenol, methyl alcohol, ethyl alcohol, and any member of the homologous series of alcohols.

Further, the reaction may take place in the presence of a catalyst. Suitable catalysts include tertiary amines, such as 1,4-diazabicyclo[2.2.2]octane (DABCO) or an alkoxide, such as butoxide. Preferably, the reaction of end capped polysuccinimide with an alcohol in the absence of water is carried out in the presence of catalyst described above.

Additional nucleophiles, such as mercaptides, may be used in accordance with this embodiment.

Further, reactive diluents, such as polyethylene oxide may be used in accordance with this embodiment. In addition, hydrophobic reactive solvents may be added. If mixed amines or mixed alcohols are used in accordance with this embodiment, the ratio of such mixture is adjusted for desired properties.

In another embodiment in accordance with the present invention the end capped polysuccinimide reacts with an amine in an aqueous solution. The reaction is shown in Reaction 6 below.

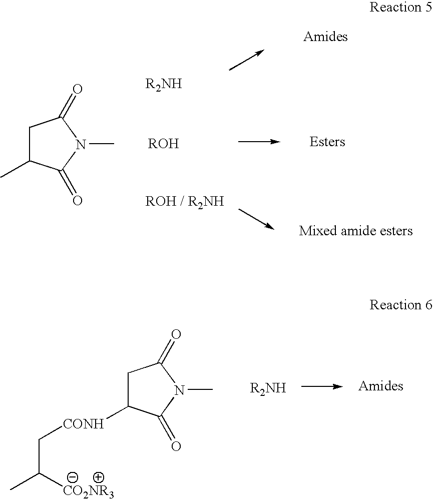

R₂NH above is used to denote one or a plurality of amines; likewise, ROH is used to denote one or a plurality of alcohols. Further, in Reaction 6 above the reaction with an amine takes place on a partially hydrolyzed polysuccimide. Partial hydrolysis takes place in the presence of any tertiary amine, such as triethanolamine.

Additional nucleophiles, such as mercaptides, may be used in accordance with this embodiment.

In addition, hydrophobic solvents may be added. If mixed amines are used in accordance with this embodiment, the ratio of such mixture is adjusted for desired properties.

Further, diluents, such as polyethylene oxide may be used in accordance with this embodiment. I addition, hydrophobic solvents may be added. If mixed amines are used in accordance with this embodiment, the ratio is adjusted for desired properties.

Suitable amines for derivatization in accordance with the present application are any primary amine, a secondary amine or a mixture thereof or secondary amine. Suitable amines include but are not limited to ethylamine, propyl amine and a member of the homologous series, ethanol amine, diethanol amine, glycol amine, an aminopolyethoxylate, an amino acid, imidazole, morpholine, an aromatic amine, a polymeric amine, a protein and chitosan.

A catalyst may be used in accordance with this embodiment as. Suitable catalysts in accordance with the present embodiment include but are not limited to triethanolamine, triallylamine, tributilamine, triethyl amine, tridodecyl amine, trihexyl amine, triisobutyl amine, triisooctyl amine, triisopropyl amine, trimethyl amine, trioctylamine, triphenyl amine, tripropyl amine, 1,4-diazabicyclo[2.2.2]octane (DABCO).

Having generally described this invention, a further understanding can be obtained by reference to certain specific examples which are provided herein for purposes of illustration only and are not intended to be limiting unless otherwise specified.

### EXAMPLES

1. Reaction of End Capped Polysuccinimide with an Amine in an Aqueous Solution

100 g. of end capped polysuccinimide polymer was dispersed in 177 g of distilled water. The succinimde content of this resin was 10.31 mEq/g so that there were a total of 1031 mEq of succinimide residues present. To this dispersion 76.8 g. of triethanolamine was added to hydrolyze 50% of the succinimide residues to the respective aspartyl:triethanolamine salt. The dispersion was placed into an 80° C. oven, with magnetic stirring until clear. This varies with the molecular weight of the polysuccinimide polymer and can take from 1 hr to about 16 hours. The product was then titrated. Theoretically there should be a total of 515 mEq of both carboxyl group from the aspartyl residue and amine groups from the triethanolamine for a total tier of 1030 mEq. In practice there is usually 10% more titer which is due to hydrolysis of extra succinimide residues by water.

2 Derivatization in the Absence of Added Water

89 g (0.87 moles/1.74 Eq of amine) of dimethylaminopropylamine (5% excess) was added to a resin kettle. The temperature was raised to 150° C. and 80 g of end capped polysuccinimide polymer (0.82 Eq of succinimide) was added to the hot amine. The mixture was stirred for 4 hours and sampled for IR and titration. The IR shows that no succinimide was left and the titration indicated that there were 0.91 Eq of amine present but no COOH functionality. Derivatization of the end capped polysuccinimide polymer was essentially 100%.

Water was added at 63° C. and stirred until a homogenous solution of the amidated polymer was obtained. It is noted that there was sufficient water in the end capped polysuccinimide polymer (4.5%) and in the amines (2%) to effect the hydrolysis.

3. Partial Derivatization and Hydrolysis in the Absence of Added Water

43 g (0.42 moles/0.84 Eq of amine) of dimethylaminopropyl amine and 62.6 g (0.42 moles) of triethanolamine were added to a resin kettle. The temperature was raised to 150° C. and 80 g of end capped polysuccinimide polymer (0.82 Eq of succinimide) was added to the hot amine. The mixture was stirred for 4 hours and sampled for IR and titration. The IR shows that no succinimide was left and the titration indicated that there were 0.84 Eq of amine present and 0.41 Eq COOH functionality. Derivatization of the end capped polysuccinimide polymer was essentially 50%.

Water was added at 63° C. and stirred until a homogenous solution of the partially amidated polymer was obtained. It is noted that there was sufficient water in the end capped polysuccinimide polymer (4.5%) and in the amines (2%) to effect the hydrolysis.

Obviously, numerous modifications and variations of the present invention are possible in light of the above teachings. It is therefore to be understood that within the scope of the appended claims, the invention may be practiced otherwise than as specifically described herein.

1. A process for forming an amide, comprising reacting an end capped polysuccinimide polymer with an amine in the absence of water.

2. A process for forming an ester, comprising reacting an end capped polysuccinimide polymer with an alcohol in the absence of water.

3. A process for forming a mixture of an amide and ester, comprising reacting an end capped polysuccinimide polymer with a mixture of an alcohol and an ester in the absence of water.

4. A process for forming an amide, comprising reacting an end capped polysuccinimide polymer with an amine in an aqueous solution.

5. The processes of claim 1, wherein said amine is selected from the group consisting of a primary amine, a secondary amine and a mixture thereof.

6. The processes of claim 1, wherein said amine is selected from the group consisting of ethylamine, propylamine, ethanolamine, diethanolamine, glycolamine, an aminopolyethoxylate, an amino acid, imidazole, morpholine, an aromatic amine, a polymeric amine, a protein and chitosan.

7. The process of claim 2, wherein said alcohol is selected from the group consisting of a primary alcohol, a secondary alcohol and mixtures thereof.

8. The process of claim 2, wherein said alcohol is selected from the group consisting of a synthetic alcohol, a natural alcohol, a starch, a cellulose, a poly(vinyl alcohol), an aliphatic, alcohol, an aromatic alcohol, methyl alcohol, ethyl alcohol, and any member of the homologous series of alcohols.

9. The process of claim 1, further comprising a catalyst.

10. The process of claim 9, wherein said catalyst is selected from the group consisting of a tertiary amine, and an alkoxide.

11. The process of claim 2, further comprising a catalyst.

12. The process of claim 12, wherein said catalyst is selected from the group consisting of a tertiary amine, and an alkoxide.

13. The process of claim 9, wherein said catalyst is selected from the group consisting of 1,4-diazabicyclo[2.2.2]octane (DABCO) and butoxide.

14. The process of claim 11, wherein said catalyst is selected from the group consisting of 1,4-diazabicyclo[2.2.2]octane (DABCO) and butoxide.

15. The amide formed by the process of claim 1.

16. The ester formed by the process of claim 2.

17. An article formed by the amide of claim 15.

18. An article formed by the ester of claim 16.
